(19) United States
(12) Patent Application Publication
(10) Pub. No.: US 2012/0030560 A1
(43) Pub. Date: Feb. 2, 2012

(54) WEBSITE BROWSING SYSTEM, SERVER, RECORDING MEDIUM, AND WEBSITE BROWSE ASSISTING METHOD

(75) Inventor: Hironori YANO, Tokyo (JP)

(73) Assignee: FUJIFILM CORPORATION, Tokyo (JP)

(21) Appl. No.: 13/184,343

(22) Filed: Jul. 15, 2011

(30) Foreign Application Priority Data
Jul. 29, 2010 (JP) JP2010-170845

(51) Int. Cl. G06F 17/00

(52) U.S. Cl. 715/234

(57) ABSTRACT

A website browse assisting method according to an aspect of the presently disclosed subject matter includes the steps of: receiving a request for desired page content from a client terminal; acquiring the requested page content; converting the acquired page content into an image; extracting UI information from the acquired page content; determining whether or not the extracted UI information is needed for the client terminal for each item of the UI information; generating UI metadata on the UI information determined to be needed for the client terminal; and transmitting the converted image and the generated UI metadata to the client terminal.

### BACKGROUND OF THE INVENTION

1. Field of the Invention

The presently disclosed subject matter relates to a website browsing system, a server, a program for the server (a recording medium for storing the program), and a website browse assisting method, and in particular, to a website browsing system, a server, a program for the server, and a website browse assisting method for browsing and operating a website for PCs (personal computers) with client terminals such as mobile phones that have restrictions on a screen size of mobile terminals and a size of a file that can be downloaded.

2. Description of the Related Art

As a network bandwidth has been increased in recent years, a growing number of web resources have come to include rich content. The “rich content” as used herein refers to structured binary data such as JPEG (Joint Photographic Experts Group), MPEG (Moving Picture Experts Group) and Flash (Adobe Flash), and HTML (HyperText Markup Language) content in which expressivity is improved by CSS (cascading style sheets), Java Script, or the like. Users access web sites and have PCs render such resources to display them on the screen, and thereby the users can have a variety of experiences.

In recent years, it has been common to browse web pages with mobile terminals such as mobile phones. However, because it is highly burdensome and expensive to create web pages for mobile terminals in addition to web pages for PCs, web site creators tend to avoid creating web pages for mobile terminals, so that very often a web page that a user desires to browse does not have a page for mobile terminals.

When a web page for PCs is browsed with a mobile terminal, which has a smaller screen size and a file size that can be downloaded than PCs, a problem is caused by restrictions of ability of the mobile terminal. Although rendering HTML is performed by a CPU (central processing unit) of a mobile terminal, since the load of rendering processing is high, often only processing from which specific functions are omitted is performed (such a cut-down version of HTML is referred to as CHTML (Compact HyperText Markup Language)). Thus, mobile terminals cannot display web pages with same expressivity as that of PCs.

To solve such a problem, there are proposed methods for creating an image of a web page for PCs to display the image on a mobile phone. For example, in Japanese Patent Application Laid-Open No. 2004-220260, an image delivering server creates a web page based on elements such as an HTML document of an acquired web page, converts the created web page into image data such as a bitmap, and transmits the image data to a client terminal. When a user clicks a displayed character string or the like with a pointing device, the client terminal on which this image data is displayed transmits clicked position coordinate data and a URL (Uniform Resource Locator) of the displayed web page to the image delivering server. The image delivering server checks whether or not there is a link pointer corresponding to the transmitted click position coordinates on the basis of the elements of the web page, and if there is the link pointer, the image delivering server accesses a web server that the URL indicated by the link pointer designates.

According to the technique disclosed in Japanese Patent Application Laid-Open No. 2004-220260, even a client terminal in which a web browser is not implemented can browse web pages.

### SUMMARY OF THE INVENTION

The technique disclosed in Japanese Patent Application Laid-Open No. 2004-220260 can recognize a link pointer (a link tag in HTML) in a web page and display a linked page corresponding to a position clicked by a user. However, this technique cannot recognize input forms other than a link tag such as text input and a checkbox. As described above, in Japanese Patent Application Laid-Open No. 2004-220260, there is a problem that not all user interface (UI) information in a web page is recognized.

In addition, in the technique described in Japanese Patent Application Laid-Open No. 2004-220260, even when a user operates an incorrect link pointer, communication with a server is made, so that unnecessary communication occurs and disadvantageously server resources are consumed wastefully.

Such an increase in communication traffic and server resource consumption is significant in portal sites having a variety of services, which decreases usability and contributes to refraining from the use because of increase in the communication cost.

The presently disclosed subject matter has been made in view of such circumstances. An object of the presently disclosed subject matter is to provide a website browsing system, a server, a program for the server, and a website browse assisting method which allow communication traffic and server resources to be reduced by preventing UI information unnecessary for a client terminal from being selected when a mobile terminal such as a mobile phone is used to browse and operate web pages for PCs.

To achieve the above-described object, a website browsing system according to a first aspect of the presently disclosed subject matter is a website browsing system including a server and a client terminal connected to the server, wherein the server includes: an acquiring device which acquires page content requested by the client terminal; a converting device which converts the acquired page content into an image; a UI information extracting device which extracts UI information from the acquired page content; a determining device which determines whether or not the extracted UI information is needed for the client terminal for each of the UI information items; a UI metadata generating device which generates UI metadata on the UI information determined, by the determining device, to be needed for the client terminal; and a first transmitting device which transmits the converted image and the generated UI metadata to the client terminal, and wherein the client terminal includes: a requesting device which requests desired page content from the server; a first receiving device which receives the image of the requested page content and the UI metadata both transmitted from the server; and a display controlling device which displays the image of the page content on a displaying device and displays the UI information on the displayed image on the basis of the UI metadata.

According to the first aspect of the presently disclosed subject matter, the website browsing system acquires page content requested by the client terminal and converts the acquired page content into an image as well as extracts UI information from the acquired page content. The website browsing system determines whether or not the extracted UI information is needed for the client terminal, generates UI metadata on the UI information determined to be needed, and transmits the converted image and the generated UI metadata to the client terminal. The client terminal displays the image on the displaying device and displays the UI information on the displayed image on the basis of the UI metadata. Thus, the client terminal displays only the needed UI information and can prevent processing and communication caused by operating unnecessary UI information. As a result, communication traffic and server resources can be reduced.

A website browsing system according to a second aspect of the presently disclosed subject matter is the website browsing system of the first aspect, wherein the UI metadata generating device generates base UI metadata on the basis of all the extracted UI information, assigns a use flag to the base UI metadata on the basis of a determination result from the determining device, and generates the UI metadata by deleting, from the base UI metadata, the UI information determined to be unnecessary for the client terminal by the determining device on the basis of the use flag.

According to the second aspect of the presently disclosed subject matter, the website browsing system generates UI metadata to be transmitted by deleting, from the base UI metadata, the UI information determined to be unnecessary for the client terminal on the basis of the use flag indicating a result of the determination by the determining device. Thus, the UI information determined to be unnecessary for the client terminal can reliably be deleted from the base UI metadata.

A website browsing system according to a third aspect of the presently disclosed subject matter is the website browsing system of the first aspect, further including a storing device which stores a URL information table including a URL and a condition linked with the URL, the condition indicating whether or not a connection to the URL is needed, wherein if the UI information is a link, the determining device determines whether or not the UI information is needed for the client terminal on the basis of the linked URL and the URL information table.

According to the third aspect of the presently disclosed subject matter, if the UI information is a link, the website browsing system determines whether or not the UI information is needed for the client terminal on the basis of a linked URL and the URL information table including the URL and the condition linked with the URL, the condition indicating whether or not a connection to the URL is needed. This allows for easily determining whether or not the UI information is needed for the client terminal.

A website browsing system according to a fourth aspect of the presently disclosed subject matter is the website browsing system of the third aspect, wherein the URL information table includes as a condition indicating whether or not a connection to the URL is needed, at least one of a domain to which the client terminal can be connected, an address of a server to which the client terminal can be connected, a size of the page content, and a time required to render the page content.

According to the fourth aspect of the presently disclosed subject matter, the website browsing system can determine whether or not the UI information is needed for the client terminal on the basis of at least one of a domain to which the client terminal can be connected, an address of a server to which the client terminal can be connected, a size of page content, and a time required to render the page content.

A website browsing system according to a fifth aspect of the presently disclosed subject matter is the website browsing system of the fourth aspect, wherein if a domain of the linked URL is included in the URL information table, the determining device determines that the UI information is needed for the client terminal. This allows for easily determining whether or not the UI information is needed for the client terminal.

A website browsing system according to a sixth aspect of the presently disclosed subject matter is the website browsing system of the fourth aspect, wherein if an address of the server storing thereon page content corresponding to the linked URL is included in the URL information table, the determining device determines that the UI information is needed for the client terminal. This allows for easily determining whether or not the UI information is needed for the client terminal.

A website browsing system according to a seventh aspect of the presently disclosed subject matter is the website browsing system of the fourth aspect, wherein if a size of the page content corresponding to the linked URL is smaller than a size of the page content included in the URL information table, the determining device determines that the UI information is needed for the client terminal. This allows for easily determining whether or not the UI information is needed for the client terminal.

A website browsing system according to an eighth aspect of the presently disclosed subject matter is the website browsing system of the fourth aspect, wherein if a time required to render the page content corresponding to the linked URL is shorter than a time required to render the page content included in the URL information table, the determining device determines that the UI information is needed for the client terminal. This allows for easily determining whether or not the UI information is needed for the client terminal.

A website browsing system according to a ninth aspect of the presently disclosed subject matter is the website browsing system of the third aspect, wherein the server further includes a present date and time acquiring device which acquires a present date and time, and wherein the determining device determines whether or not the UI information is needed for the client terminal on the basis of the linked URL, information of a date and time when the client terminal can be connected, the date and time information being stored in the URL information table and linked with the linked URL, and the acquired present date and time.

According to the ninth aspect of the presently disclosed subject matter, the website browsing system determines whether or not the UI information is needed for the client terminal on the basis of the linked URL, the information of the date and time when the client terminal can be connected, the date and time information being stored in the URL information table and linked with the linked URL, and a present date and time. This allows for easily determining whether or not the UI information is needed for the client terminal.

A website browsing system according to a tenth aspect of the presently disclosed subject matter is the website browsing system of the third aspect, wherein the server further includes a position information acquiring device which acquires position information of the client terminal, and wherein the determining device determines whether or not the UI information is needed for the client terminal on the basis of the linked URL, information of a position to which the client terminal can be connected, the position information being stored in the URL information table and linked with the linked URL, and the acquired position information.

According to the tenth aspect of the presently disclosed subject matter, the website browsing system determines whether or not the UI information is needed for the client terminal on the basis of the linked URL, the information of the position to which the client terminal can be connected, the position information being stored in the URL information table and linked with the linked URL, and position information of the client terminal. This allows for easily determining whether or not the UI information is needed for the client terminal.

A website browsing system according to an eleventh aspect of the presently disclosed subject matter is the website browsing system of the first aspect, further including a storing device which stores a user ID table including a user ID of the client terminal and attributes of the user ID, the attributes being linked with the user ID, wherein if the UI information is a form, the determining device determines whether or not the UI information is needed for the client terminal on the basis of attributes of the UI information and the attributes in the user ID table.

According to the eleventh aspect of the presently disclosed subject matter, the website browsing system determines whether or not the UI information is needed for the client terminal on the basis of the attributes of the UI information and the attributes linked with the user ID of the client terminal included in the user ID table. This allows for easily determining whether or not the UI information is needed for the client terminal.

A server according to a twelfth aspect of the presently disclosed subject matter constitutes the website browsing system according to first aspect.

A non-transitory computer-readable recording medium according to a thirteenth aspect of the presently disclosed subject matter including instructions stored thereon, such that when instructions are read and executed by a processor of a server, the processor is configured to perform the steps of: receiving a request for desired page content from a client terminal; acquiring the requested page content; converting the acquired page content into an image; extracting UI information from the acquired page content; determining whether or not the extracted UI information is needed for the client terminal for each item of the UI information; generating UI metadata on the UI information determined to be needed for the client terminal; and transmitting the converted image and the generated UI metadata to the client terminal.

A website browse assisting method according to a fourteenth aspect of the presently disclosed subject matter includes the steps of: receiving a request for desired page content from a client terminal; acquiring the requested page content; converting the acquired page content into an image; extracting UI information from the acquired page content; determining whether or not the extracted UI information is needed for the client terminal for each item of the UI information; generating UI metadata on the UI information determined to be needed for the client terminal; and transmitting the converted image and the generated UI metadata to the client terminal.

A website browse assisting method according to a fifteenth aspect of the presently disclosed subject matter is the website browse assisting method of the 14th aspect, further including the steps of: receiving the transmitted image and the UI metadata by the client terminal; and displaying the received image on a displaying device of the client terminal and displaying the UI information on the displayed image on the basis of the UI metadata.

According to the presently disclosed subject matter, when a mobile terminal such as a mobile phone is used to browse and operate a web page for PCs, communication traffic and server resources can be reduced by preventing UI information unnecessary for a client terminal from being selected.

### BRIEF DESCRIPTION OF THE DRAWINGS

FIG. 1 illustrates an example of an overall configuration of a web page browsing system 100;

FIG. 2 is a flow chart illustrating an operation flow until displaying a desired web page on a displaying unit 13 of a client terminal 10;

FIGS. 3A to 3C are diagrams for illustrating generation of UI metadata;

FIG. 4 illustrates UI metadata stored as a CSV (comma separated value format) file;

FIG. 5 is a flow chart illustrating a flow of processing by a UI analyzing unit 25 to determine unnecessary UI information and assign a use flag to the UI metadata;

FIG. 6 illustrates a URL information table;

FIG. 7 illustrates an availability determination table;

FIG. 8 illustrates a user ID table;

FIG. 9 illustrates UI metadata to which use flags are assigned;

FIG. 10 is a flow chart illustrating internal processing of the client terminal 10;

FIGS. 11A to 11C are diagrams for illustrating rewriting of the UI metadata;

FIGS. 12A to 12C are diagrams for illustrating rewriting of the UI metadata; and

FIG. 13 is a flow chart illustrating an operation flow when a UI operation is performed with the client terminal 10.

### DETAILED DESCRIPTION OF THE PREFERRED EMBODIMENT

Hereinafter, an embodiment of the presently disclosed subject matter will be described with reference to the involving drawings.

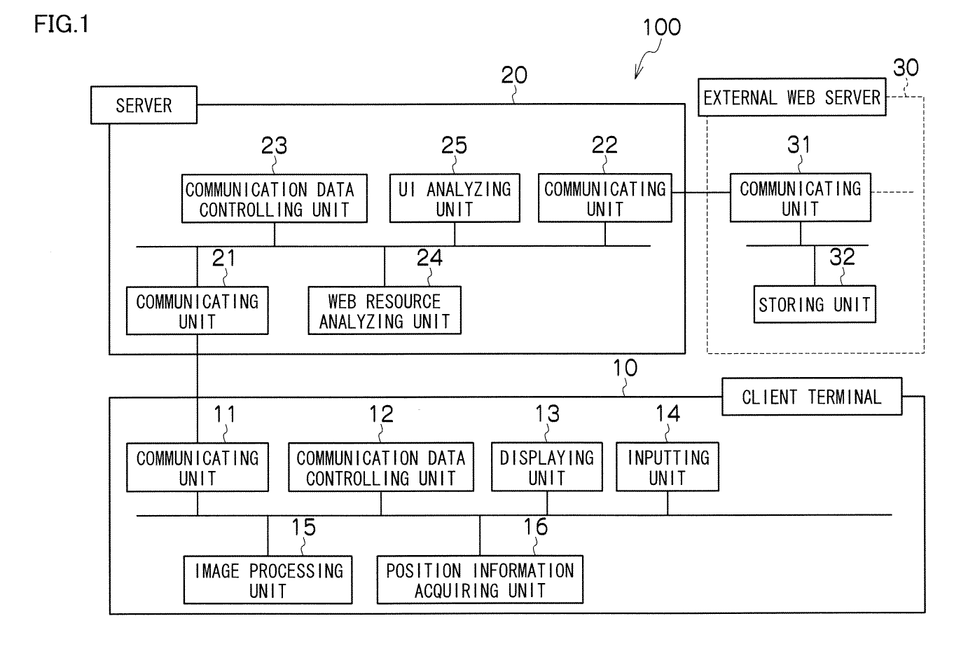

FIG. 1 illustrates an example of an overall configuration of a web page browsing system 100 according to the embodiment. As illustrated in FIG. 1, the web page browsing system 100 includes a client terminal 10 used by a user, a server 20 connected to the client terminal 10, and an external web server 30 connected to the server.

The client terminal 10 is a mobile terminal such as a mobile phone and a PDA (personal digital assistance), and the client terminal 10 includes a communicating unit 11, a communication data controlling unit 12, a displaying unit 13, an inputting unit 14, and an image processing unit 15.

The communicating unit 11 controls communication with the server 20 according to a predetermined protocol. The client terminal 10 is connected with the server 20 via the Internet. The communicating unit 11 and a communicating unit 21 described later is communicated with each other according to a standard Internet protocol such as TCP/IP (Transmission Control Protocol/Internet Protocol). It should be noted that the client terminal 10 and the server 20 may be connected to each other via a dedicated communication line or a VPN (virtual private network). As a result of communication, a request is transmitted from the communicating unit 11 to the server 20 and a response from the server 20 is received by the communicating unit 11.

The displaying unit 13 is a liquid crystal display which can perform color display. The displaying unit 13 displays an image on the basis of an image signal input by the image processing unit 15. It should be noted that another type of display such as an organic EL (electroluminescence) display may also be adopted instead of the liquid crystal display.

The communication data controlling unit 12 performs received data control and transmitted data control. As the received data control, the communication data controlling unit 12 analyzes data acquired by the communicating unit 11 and outputs a result of the analysis to the image processing unit 15. As the transmitted data control, the communication data controlling unit 12 determines whether or not additional page information is required (for example, whether or not there is screen scrolling, zooming, page transitions, or the like) on the basis of a command output by the inputting unit 14. If such information is required, the communication data controlling unit 12 transmits a command to the server 20 via the communicating unit 11.

The inputting unit 14 includes a power button, numeral keys, arrow keys, and a determination key, not illustrated. A user can operate the client terminal 10 by operating the inputting unit 14. Also, a touch panel may be placed on the screen of the displaying unit 13 and used as the inputting unit 14. The inputting unit 14 converts information such as pressing of a certain button into a variety of commands and outputs the commands to the communication data controlling unit 12 or the like.

The image processing unit 15 allows the displaying unit 13 to display an image received from the server 20 via the communicating unit 11. The image processing unit 15 also performs processing which is based on the user's inputting operation through the inputting unit 14.

A position information acquiring unit 16 is GPS (global positioning system), for example. The position information acquiring unit 16 acquires position information of the client terminal 10.

The server 20 includes communicating units 21 and 22, a communication data controlling unit 23, a web resource analyzing unit 24, and a UI analyzing unit 25.

The communicating unit 21 controls communication with the client terminal 10. As a result of the communication, a request from the client terminal 10 is received by the communicating unit 11 and a response to the request is transmitted from the communicating unit 21 to the client terminal 10.

The communicating unit 22 controls communication with an external web server 30. The server 20 is connected to the external web server 30 via the Internet. The communicating unit 21 and a communicating unit 31 described later is communicated with each other according to a standard Internet protocol. As a result of the communication, a web page is requested from the external web server 30 by the communicating unit 22 and the web page transmitted from the external web server 30 is received by the communicating unit 22.

The communication data controlling unit 23 controls acquired communication data. Specifically, if a web page is acquired from the external web server 30, the communication data controlling unit 23 outputs the data to the web resource analyzing unit 24. Also, if a request from the mobile terminal relates to an operation of a web page, the communication data controlling unit 23 outputs operating information to the web resource analyzing unit 24. In addition, if a request from the mobile terminal is to acquire a web page, the communication data controlling unit 23 transmits a web page acquiring request to the external web server 30 via the communicating unit 22.

The web resource analyzing unit 24 generates a file of the same image as an image which can be seen when the content file is browsed. A file is made on the basis of page content (a content file) acquired from the external web server 30 via the communicating unit 21. Here, the image file is generated with a predetermined resolution. However, the image file with a resolution which is based on contents of a content file or with a resolution of the client terminal 10 may also be generated.

Also, the web resource analyzing unit 24 extracts UI information from the acquired content file and then analyzes a type and a position of the UI information to generate UI metadata.

In addition, the web resource analyzing unit 24 processes the acquired web resource on the basis of the operating information transmitted from the client terminal 10.

The UI analyzing unit 25 determines whether or not the UI information extracted by the web resource analyzing unit 24 is needed for the client terminal 10, and adds a use flag to the UI metadata. The UI analyzing unit 25 deletes UI information which is unnecessary for the client terminal 10 from the UI metadata. The processing carried out by the UI analyzing unit 25 will be described later in detail.

The external web server 30 includes the communicating unit 31 and a storing unit 3

The communicating unit 31 controls communication with the server 20. The storing unit 32 stores each content file of a web page opened in the external web server 30. The communicating unit 31 reads out from the storing unit 32 a file corresponding to a URL request received from the server 20 and transmits the file to the server 20.

It should be noted that FIG. 1 illustrates the single client terminal 10, but there are a large number of client terminals 10 which can communicate with the server 20, and each of the client terminals 10 communicates with the server 20 individually. Also, there are a large number of external web servers 30 on the Internet and the server 20 can communicate with each of the external web servers 30. As described above, regardless of which of the client terminals 10 accesses which of the external web servers 30, the communication is provided via the server 20.

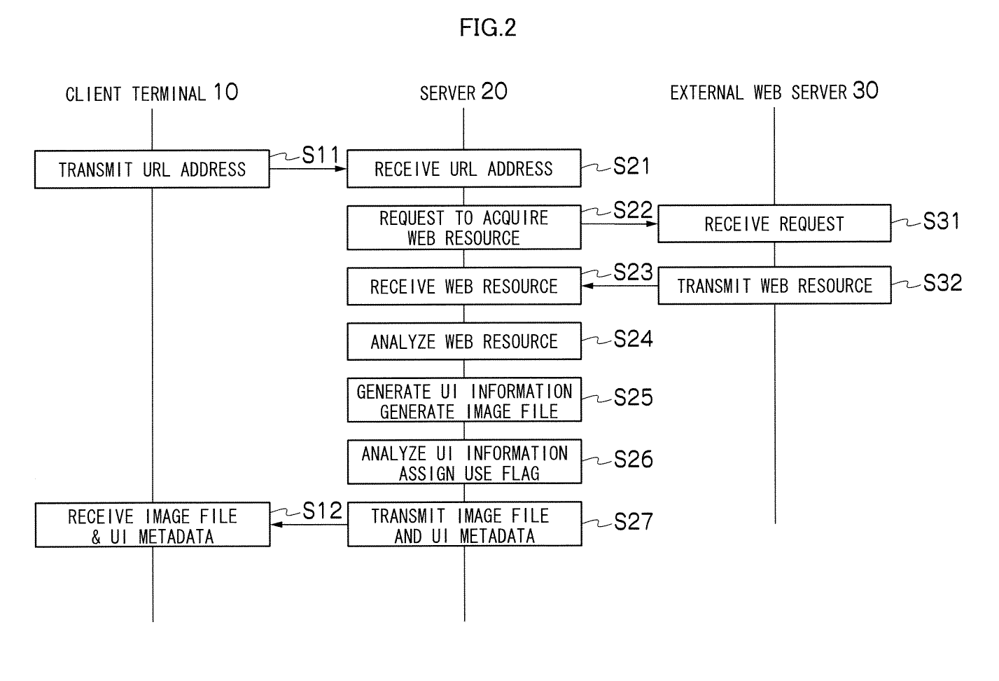

Next, the operation of the web page browsing system 100 having such configuration will be described. First of all, an operation from the start to displaying a desired web page on the displaying unit 13 of the client terminal 10 will be described with reference to FIG. 2.

The user inputs a URL of a web page which the user desires to browse by using the inputting unit 14 of the client terminal 10. In addition to inputting a character string directly, the user may also select a URL with a bookmark or the like registered on a storing unit (not illustrated) of the client terminal 10. After inputting the URL, when the user instructs to transmit the URL with a transmitting button of the inputting unit 14, the communicating unit 11 transmits the input URL to the server 20 (step S11).

It should be noted that as bookmarks in a storing unit (not illustrated) of the server 20, web page titles and URLs are pre-stored and one may also be selected from these web page titles. In this case, the server 20 transmits the stored web page titles to the client terminal 10 via the communicating unit 21, and the client terminal 10 receives these web page titles via the communicating unit 11. In addition, the image processing unit 15 allows the received web page titles to be displayed on the displaying unit 13. The user selects a desired web page from the displayed web page titles by using the inputting unit 14. Then, the client terminal 10 may transmit the selected web page title to the server 20 via the communicating unit 11.

The server 20 receives the URL transmitted from the client terminal 10 via the communicating unit 21 (step S21). In addition, the communicating unit 22 transmits the received URL to the external web server 30 corresponding to the URL (step S22). When a web page title is selected from the bookmarks in the server 20, the server 20 may read out a corresponding URL from the storing unit, not illustrated, and transmit the corresponding URL to the corresponding external web server 30.

The corresponding external web server 30 receives this URL via the communicating unit 31 (step S31). Then, the external web server 30 reads out from the storing unit 32 a content file such as an HTML file, a CSS file, and a Java (registered trademark) Script file corresponding to the received URL, and transmits the content file to the server 20 via the communicating unit 31 (step S32).

The server 20 receives the content file transmitted from the external web server 30 (step S23), analyzes the received content file by the web resource analyzing unit 24, and extracts UI information (step S24). A method for analyzing content files is not particularly limited. A known technique for parsing a content file to extract a tag may be used.

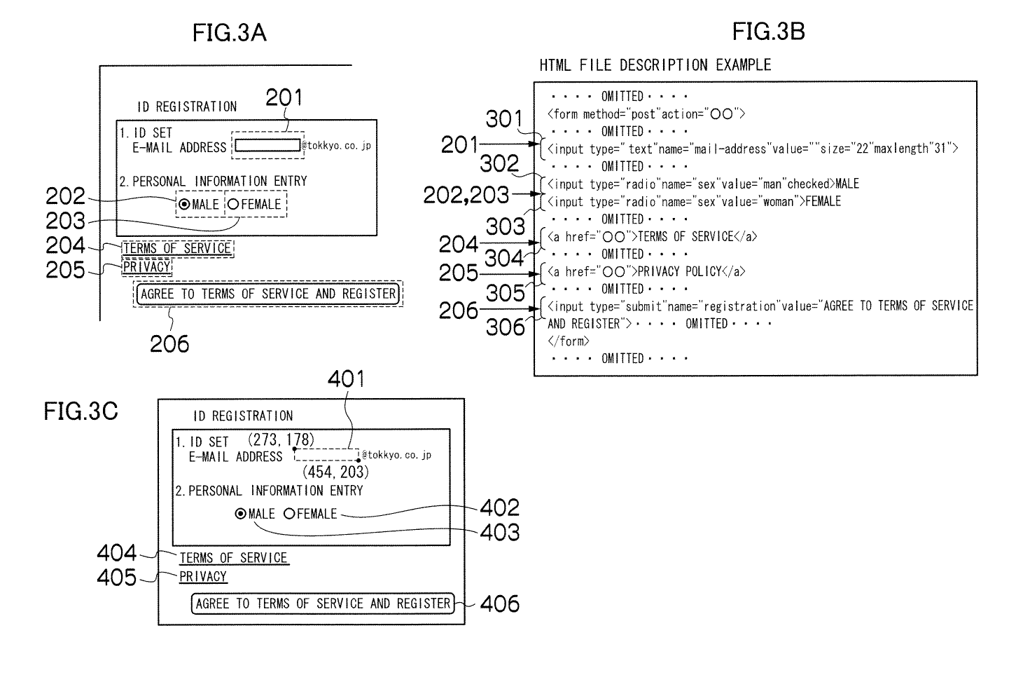

The web resource analyzing unit 24 generates UI metadata on the basis of a result of the analysis (step S25). The generation of the UI metadata carried out when a web page is received in step S23 will be described with reference to FIGS. 3A and 3B. FIG. 3A illustrates an extracted upper left part of the web page. FIG. 3B illustrates descriptions taken from an HTML file corresponding to the portion illustrated in FIG. 3A. It should be noted that in the HTML file illustrated in FIG. 3B, unnecessary portions are omitted as needed.

The web resource analyzing unit 24 extracts UI information such as a link tag and an inputting form from the HTML file illustrated in FIG. 3B to calculate position coordinates of each item of the UI information in FIG. 3A.

For example, six tags, namely, a text input field tag 301, a radio button tag 302, a radio button tag 303, a link tag 304, a link tag 305, and a button tag 306 are described in the HTML file illustrated in FIG. 3B. The web resource analyzing unit 24 extracts these tags from the HTML file to extract the UI information items 201 to 206.

In addition, in a condition where the HTML file is being browsed, the UI information items 201 to 206 are positioned in respective positions on the screen illustrated in FIG. 3A. The web resource analyzing unit 24 acquires a starting and an ending XY coordinate values (coordinate values corresponding to an upper left point and a lower right point) of these UI information items. Methods for acquiring coordinate values are not particularly limited, and techniques of storing the values while rendering an image or acquiring the values from a browser may be used, for example.

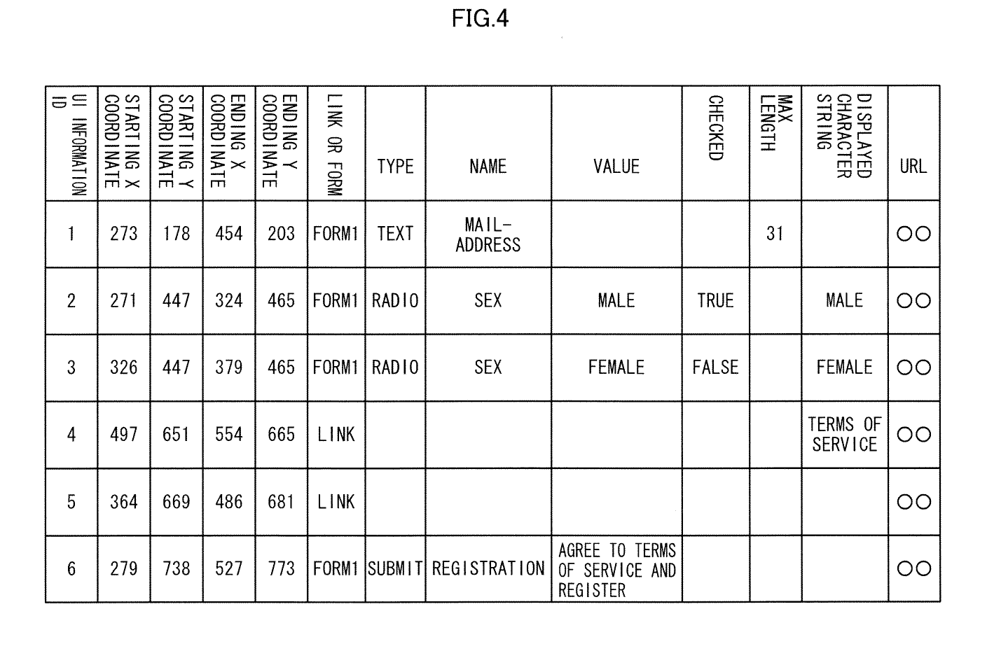

Each item of the UI information and its position information extracted as described above are linked with each UI information ID and stored as UI metadata in the storing unit (not illustrated) of the server 20. FIG. 4 illustrates the UI metadata of the web page illustrated in FIG. 3A, the UI metadata being stored as a CSV file.

The UI metadata includes the coordinate values corresponding to an upper left point and a lower right point of the UI information, UI information attributes (here, a UI information type (a link or a form), a form type (a text button, a radio button, and the like), a name, a value, and the like) and the coordinate values and the attributes are linked with a UI information ID assigned for each UI information item. In addition, each UI information ID is linked with a URL. If the UI information type is a link, a linked URL is linked with the UI information ID with reference to the HTML file. For example, in a case of the UI information 204, the UI information ID is linked with the URL included in the link tag 304. If the UI information type is a form, the URL based on a type of the form is linked. It should be noted that attributes related to screen display such as a layout (e.g., a size attribute) need not be included in the UI metadata.

The UI metadata is linked stored in the storing unit with an address and an HTML file of a web page on which the UI metadata is based. For example, the UI metadata illustrated in FIG. 4 is linked with the address of the web page illustrated in FIG. 3A and the HTML file illustrated in FIG. 3B, and stored. Note that the storing of the HTML file is not necessary.

The web resource analyzing unit 24 also renders the acquired content file to generate an image file in a format such as jpeg or bitmap that can be displayed on the displaying unit 13 of the client terminal 10 (step S25). It should be noted that methods for generating image files are not particularly limited and known techniques may be used.

FIG. 3C illustrates an image obtained by rendering the HTML file illustrated in FIG. 3B. A position and a type of the UI information in this image can be known by referring to the UI metadata illustrated in FIG. 4. For example, it can be seen that a UI information item corresponding to each of the tags 301 to 306 is positioned in each of positions 401 to 406 illustrated in FIG. 3C, and these positions are same as those of the UI information items 201 to 206 in the browsed condition illustrated in FIG. 3A. This image file is stored in the storing unit (not illustrated) of the server 20 with the UI metadata.

The UI analyzing unit 25 determines whether or not each of the UI information items is needed for the client terminal 10 and deletes the UI information that is not needed for the client terminal 10 from the UI metadata (hereinafter, referred to as base UI metadata) generated in step S25 (step S26).

A method for determining whether or not the UI information is needed for the client terminal 10 will be described. Because a process flow of the method depends on a UI information type, namely, a URL linked with the UI information in the UI metadata, the flow will be described for each of the UI information items. The UI analyzing unit 25 can determine the UI information type by analyzing a URL linked with the UI information.

(A) In the Case where the UI Information Type is a Link

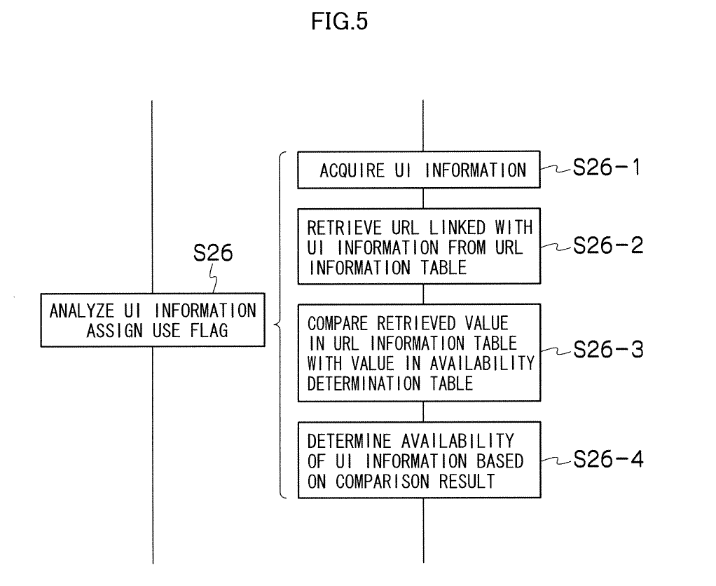

FIG. 5 is a flow chart illustrating a flow of processing by the UI analyzing unit 25 to determine whether or not each UI information item is needed for the client terminal 10.

The UI analyzing unit 25 selects predetermined UI information and refers to the UI metadata to acquire the URL linked with the UI information (step S26-1).

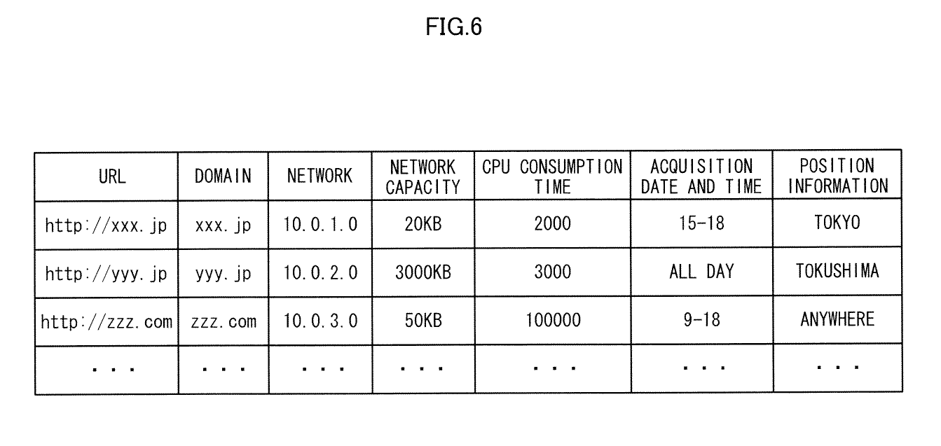

If the UI information type is a link (in FIG. 3A, the UI information items 204 and 205), the UI analyzing unit 25 refers to a URL information table as illustrated in FIG. 6 to retrieve the URL linked with the UI information from the URL information table. If the URL information table does not have the URL linked with the UI information, the UI analyzing unit 25 adds information of this URL to the URL information table (step S26-2).

The URL information table will be described. The URL information table stores a URL and a condition being linked with the URL and indicating whether or not a connection to the URL is needed. Examples of the condition indicating whether or not the connection to the URL is needed include a domain, a network (ex. an IP address), network capacity, a CPU consumption time, an acquisition date and time, position information, and the like with these elements associated with each other. They are stored in a storage area (not illustrated) in the UI analyzing unit 25.

The domain indicates a position of a computer connected to a network and can be extracted from a part of a URL. The network is an address of a server (the external web server 30 or the like) in which a content file is stored, and can be converted into from the domain. The items of the domain and the network are added when information of the URL is added to the URL information table.

The network capacity is capacity of a network required to transmit, from the server 20 to the client terminal 10, UI metadata and an image file generated from the page content corresponding to the URL. The item of the network capacity is added after an image file and UI metadata are transmitted to the client terminal 10 via the communicating unit 21.

The CPU consumption time is a time required for the web resource analyzing unit 24 to generate UI metadata and an image file from the page content corresponding to the URL. The item of the CPU consumption time is added after the web resource analyzing unit 24 generates the image file and the UI metadata.

The acquisition date and time is information of a date and time when the client terminal 10 can acquire the URL. The position information is information of a position where the client terminal 10 can acquire the URL. The acquisition date and time and the position information are set for each URL and are not added until the set entry by the server 20 or the client terminal 10. The acquisition date and time and the position information can be rewritten by the client terminal 10 and the server 20.

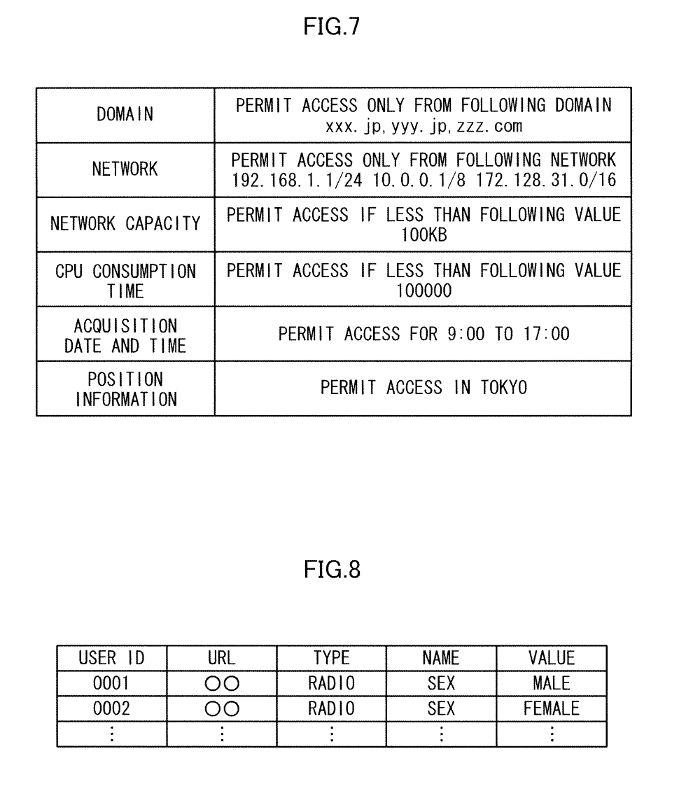

The UI analyzing unit 25 extracts the URL linked with the UI information from the URL information table, compares a condition indicating whether or not a connection to a URL linked with this URL is needed, with an availability determining table illustrated in FIG. 7 (step S26-3), and determines availability of the UI information on the basis of a comparison result (step S26-4).

As illustrated in FIG. 7, the availability determining table includes a determining criterion linked with each of the conditions indicating whether or not a connection to a URL is needed (a domain, a network (an IP address), network capacity, a CPU consumption time, an acquisition date and time, position information, and the like). The availability determining table is set for each client terminal 10 and stored in the storage area (not illustrated) of the UI analyzing unit 25. The availability determining table can be rewritten by the client terminal 10 and the server 20.

Steps S26-3 and S26-4 will be described by taking the UI information 204 illustrated in FIG. 3A as an example.

The UI analyzing unit 25 retrieves a URL linked with the UI information 204 in UI metadata from the URL information table and determines whether or not the connection to the URL linked with the retrieved URL in the URL information table is needed on the basis of any one of the conditions. The condition (for example, the domain, the network, the network capacity, the CPU consumption time, the acquisition date and time, and the position information) indicates whether or not the connection is needed. The information on which of the conditions is used for the determination among the conditions indicating whether or not the connection to the URL is needed and the condition to be used are preset for each client terminal 10 and stored in the storage area (not illustrated) in the UI analyzing unit 25.

The case in which the URL linked with the UI information 204 is “http://xxx” will be described as an example.

(1) The Case in which the Determination is Based on a Domain

A domain of the URL “http://xxx.jp” is “xxx.jp”. FIG. 7 illustrates that an access from the domain “xxx.jp” is permitted. Therefore, as a result of the comparison, the UI analyzing unit 25 determines that the UI information 204 is UI information needed for the client terminal 10.

(2) The Case in which the Determination is Based on a Network

A network of the URL “http://xxx.jp” is “10.0.1.0”. FIG. 7 does not illustrate that an access from the domain “10.0.1.0” is permitted. Therefore, as a result of the comparison, the UI analyzing unit 25 determines that the UI information 204 is not the UI information needed for the client terminal 10.

(3) The Case in which the Determination is Based on Network Capacity

Network capacity of the URL “http://xxx.jp” is “20 KB”. FIG. 7 illustrates that connection is permitted if the capacity is lower than 100 KB. Therefore, as a result of the comparison, the UI analyzing unit 25 determines that the UI information 204 can be accessed with the client terminal 10, that is, the UI information 204 is necessary UI information.

(4) The Case in which the Determination is Based on a CPU Consumption Time

A CPU consumption time of the URL “http://xxx.jp” is “2,000 hours”. FIG. 7 illustrates that the connection is permitted if the CPU consumption time is lower than 100,000. Therefore, as a result of the comparison, the UI analyzing unit 25 determines that the UI information 204 can be accessed with the client terminal 10, that is, the UI information 204 is necessary UI information.

(5) The Case in which the Determination is Based on an Acquisition Date and Time

An acquisition date and time of the URL “http://xxx.jp is “15:00 to 18:00”. FIG. 7 illustrates that the connection is permitted if the acquisition date and time is “9:00 to 17:00.” Therefore, the UI analyzing unit 25 acquires a present date and time from an internal clock (not illustrated) and if the present date and time is within an overlapping range of “15:00 to 18:00” and “9:00 to 17:00,” namely, “15:00 to 17:00,” as a result of the comparison, the UI analyzing unit 25 determines that the UI information 204 can be accessed with the client terminal 10, that is, the UI information 204 is necessary UI information. On the other hand, if the present date and time is not “15:00 to 17:00,” as a result of the comparison, the UI analyzing unit 25 determines that the UI information 204 cannot be accessed with the client terminal 10, that is, the UI information 204 is unnecessary UI information.

(6) The Case in which the Determination is Based on Position Information

Position information of the URL “http://xxx.jp” is “Tokyo”. FIG. 7 illustrates that the connection in Tokyo is permitted. Therefore, the UI analyzing unit 25 acquires position information from the position information acquiring unit 16 via the communicating unit 21 or the like and if the acquired position information is “Tokyo,” as a result of the comparison, the UI analyzing unit 25 determines that the UI information 204 can be accessed with the client terminal 10, that is, the UI information 204 is necessary UI information. On the other hand, if the acquired position information is not “Tokyo,” as a result of the comparison, the UI analyzing unit 25 determines that the UI information 204 cannot be accessed with the client terminal 10, that is, the UI information 204 is unnecessary UI information.

Actually, not all of (1) through (6) are required to be done. Since the storage area (not illustrated) in the UI analyzing unit 25 stores information on which of the conditions indicating whether or not the connection to the URL is needed is used for the determination, final determination is made on the basis of the information. For example, if an indication to use a domain to make the determination is stored, the UI analyzing unit 25 may make the determination by using only (1).

(B) The Case in which the UI Information Type is not a Link

If the UI information type is not a link (in FIG. 3A, the UI information items 201, 202, 203, and 206), the UI analyzing unit 25 refers to a user ID table as illustrated in FIG. 8.

The user ID table stores a user ID (synonymous with the client terminal 10), a URL, attributes of the user ID (here, a type (a text button, a radio button, or the like), a name, and a value) with these elements linked with each other. They are stored in the storage area (not illustrated) in the UI analyzing unit 25.

First, the UI analyzing unit 25 compares attributes (a type, a name, and a value) linked with a URL linked with the UI information, URL linked with the UI information being included in the URLs linked with the user ID corresponding to the client terminal 10 and written in the user ID table, to attributes (a type, a name, and a value) linked with UI information of the UI metadata and determines whether or not the UI information is necessary on the basis of a comparison result.

For example, in a case of the UI information 202 illustrated in FIG. 3A, the type linked with the UI information of the UI metadata is “radio”, the name is “sex”, and the value is “male”, and the type of the user ID table is “radio”, the name is “sex”, and the value is “male”. The UI analyzing unit 25 determines that the UI information 202 is necessary UI information. In a case of the UI information 203 illustrated in FIG. 3A, the type linked with the UI information of the UI metadata is “radio”, the name is “sex”, and the value is “female”, and the type of the user ID table is “radio”, the name is “sex”, and the value is “male”. The UI analyzing unit 25 determines that the UI information 202 is unnecessary UI information.

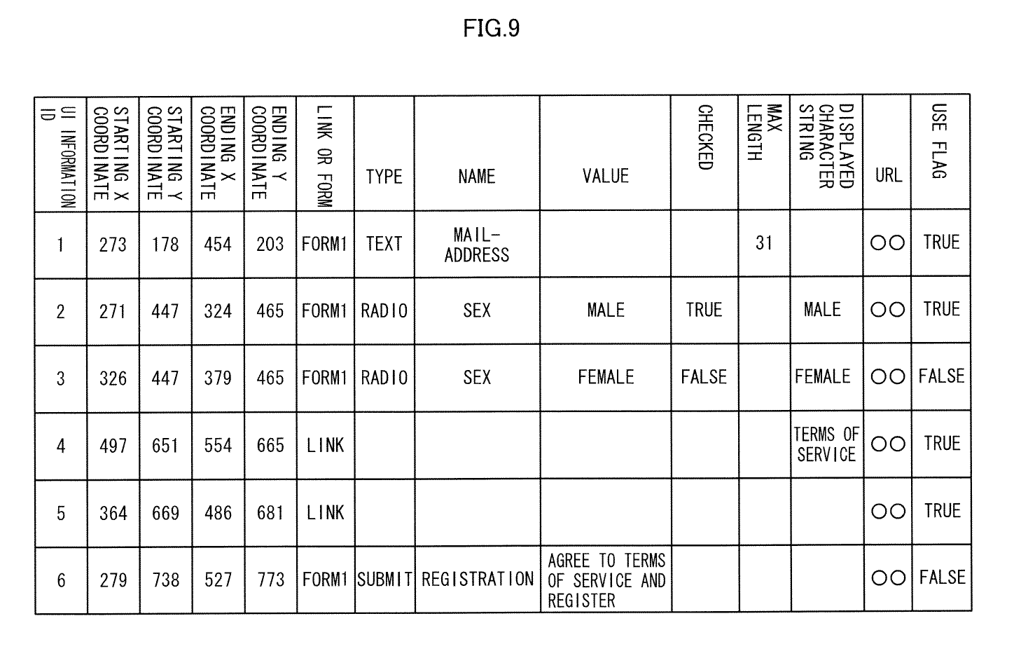

The UI analyzing unit 25 assigns a use flag to the base UI metadata on the basis of a determination result. FIG. 9 illustrates a case in which a use flag is assigned to the UI metadata illustrated in FIG. 4. To the UI information determined to be necessary for the client terminal 10, a use flag “true” is assigned and to the UI information determined to be unnecessary for the client terminal 10, a use flag “false” is assigned.

The UI analyzing unit 25 deletes from the base UI metadata the UI information to which the use flag “false” is assigned and generates the UI metadata on UI information needed for the client terminal 10 as UI metadata to be transmitted.

The server 20 transmits the UI metadata generated in step S26, namely, the UI metadata on the UI information needed for the client terminal 10 and the image file to the client terminal 10 via the communicating unit 21 (step S27). At this time, the base content file is linked with the client terminal 10, to which the UI metadata is transmitted, and with the generated UI metadata, and is stored in the storing unit, not illustrated.

The client terminal 10 receives the UI metadata and the image file via the communicating unit 11 (step S12).

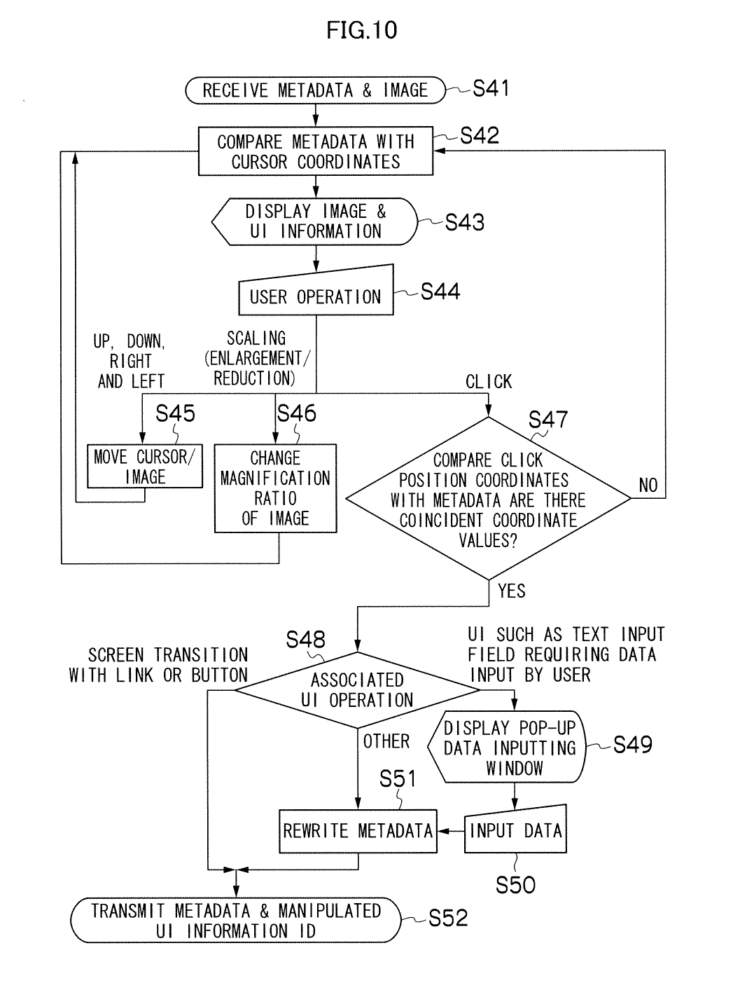

Next, internal processing in the client terminal 10, which has received the UI metadata and the image file, will be described with reference to FIG. 10.

When the client terminal 10 receives the UI metadata on the UI information needed for the client terminal 10 and the image file via the communicating unit 11 (step S41), the image processing unit 15 compares position coordinates of each UI information item included in the received UI metadata with position coordinates of a cursor displayed on the displaying unit 13 (step S42) and displays the image file and the UI information on the displaying unit 13 on the basis of a comparison result (step S43).

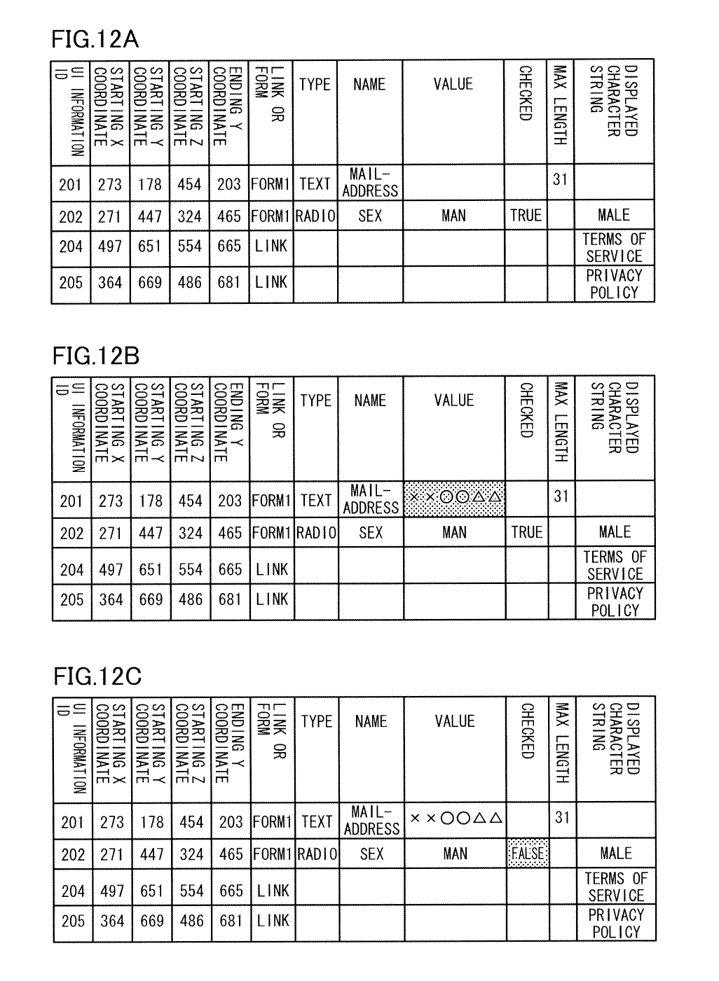

In this embodiment, since the UI metadata from which the UI information determined to be unnecessary for the client terminal 10 is deleted in step S26 is transmitted, the UI information items 203 and 206 illustrated in FIG. 3A are not transmitted (see FIG. 12A). Therefore, the displaying unit 13 does not display the UI information items 203 and 206 and displays only the UI information items 201, 202, 204, and 205. Accordingly, only the UI information items 201, 202, 204, and 205 can be selected.

For example, when the position coordinates of the cursor overlap the position coordinates of the UI information, a mark is placed on a position of the corresponding UI information to allow the user to recognize that the UI information can be selected. This mark may be substituted for an underline or a box. It should be noted that here, when the cursor is within a rectangular area defined by the XY coordinate values of each UI information item stored in the UI metadata, it is assumed that the position coordinates of the UI information overlap the position coordinates of the cursor. In addition, instead of the overlapping condition, such a mark may also be placed on the image of the displayed UI information all the time. Conversely, when the position coordinates of the cursor overlap the position coordinates of the UI information, a color or a shape of the cursor may be changed.

As described above, since the UI information determined to be unnecessary for the client terminal 10 cannot be selected with the client terminal 10 unnecessary processing can be prevented.

If a user operation is now performed through the inputting unit 14 (step S44), the display of the displaying unit 13 is changed in accordance with the operation value.

For example, when a vertical or horizontal movement operation is performed with arrow keys or the like, the cursor or an image is moved in accordance with the operation (step S45). In addition, when a scaling operation is performed in step S44, an image is scaled in accordance with the operation (step S46). At this time, because there is no communication between the client terminal 10 and the server 20, the cost does not increase as well as the usability does not decrease.

Also, when an operation with a determination button (a click operation) is performed in step S44, determination is made whether or not the cursor position overlaps a position of an image of the UI information on the basis of the comparison result obtained in step S42 (step S47).

If the cursor position does not overlap the position of the image of the UI information, the image processing unit 15 ignores this click operation and the flow of the processing returns to step S42. Then, the same processing is repeated.

If the cursor position overlaps the position of the image of the UI information, the image processing unit 15 determines the type of the UI information in a position overlapping the cursor position on the basis of the UI metadata (step S48).

The types of UI information may be the following three information items: (1) the UI information such as a text input field, which requires a user's input, (2) the UI information such as a checkbox and a radio button, which does not involve screen transitions and does not require data input, and (3) the UI information such as a link and a button, which involves screen transitions.

When the type of the UI information at the cursor position is (1) the UI information such as a text input field, which requires a user's data input, first of all, the process displays a data input screen on the displaying unit 13 by using a pop-up window or the like, and then makes the user to perform an input operation (step S49). The user inputs necessary data with the inputting unit 14 through this input screen (step S50). The image processing unit 15 rewrites the UI metadata stored in the storing unit, not illustrated, in accordance with the user's input (step S51). The rewritten UI metadata and a rewritten UI information ID are transmitted to the server 20 via the communicating unit 11 (step S52).

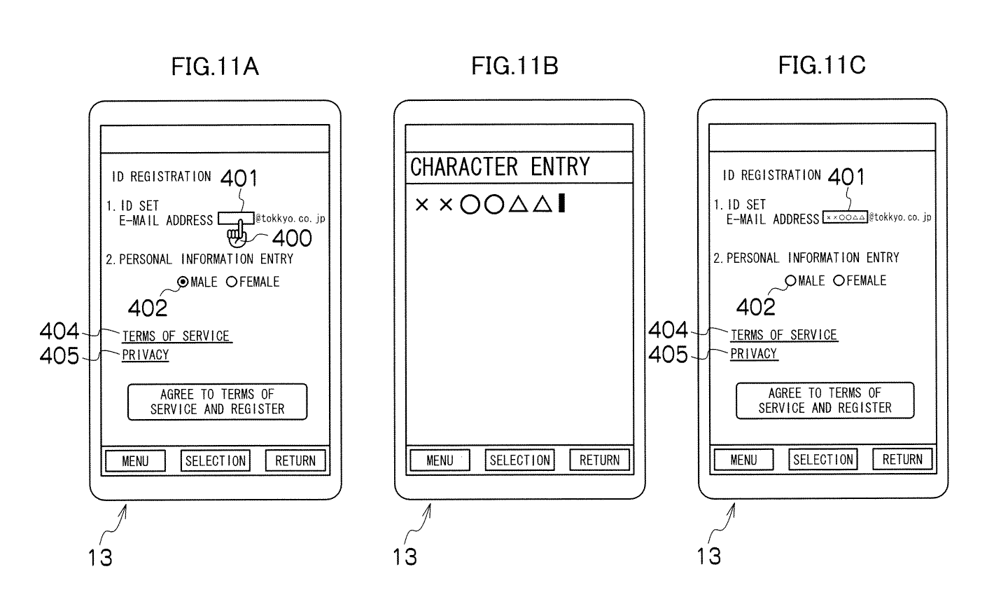

Now, details of the UI metadata rewriting will be described with reference to FIGS. 11 and 12.

FIG. 11A illustrates the display of the displaying unit 13 on which the image illustrated in FIG. 3C is being displayed. Each of the positions 401, 402, 404, and 405 on the displayed image displays each of the UI information items 201, 202, 204, and 205 as illustrated in the UI metadata illustrated in FIG. 12A. Now, when the user moves the cursor 400 onto the position 401 corresponding to the text input field 201 and performs a click operation with the determination button, the displaying unit 13 displays a text inputting pop-up window as illustrated in FIG. 11B.

The user inputs desired characters with the inputting unit 14 through this pop-up window. After the text inputting, when the click operation is performed with the inputting unit 14, the image processing unit 15 rewrites the attribute “value” of the UI information 201 corresponding to the position 401 on the basis of the input text. Here, as illustrated in FIG. 11B, since the user inputs “XXOOΔΔ” into the text inputting pop-up window, the attribute “value” of the UI information 201 is rewritten as “XXOOΔΔ,” as illustrated in FIG. 12B. The rewritten UI metadata and a rewritten (manipulated) UI information ID (here, 201) are transmitted to the server 20 via the communicating unit 11.

Next, the case in which the type of the UI information at the cursor position is the type which (2) does not involve screen transitions and does not require data input will be described.

When the user moves the cursor 400 onto the position 402 corresponding to the UI information 202 and performs a click operation with the determination button, the image processing unit 15 determines the type of the UI information at a position overlapping the cursor position on the basis of the UI metadata.

Here, the UI information 202 is a radio button, which is the UI information that does not require the user to input data and does not involve screen transitions, so that the flow of the processing proceeds to step S51, where the image processing unit 15 rewrites data on the UI information 202 from the UI metadata stored in the storing unit, not illustrated. FIG. 12C illustrates the UI metadata rewritten in this process. As illustrated in this figure, the attribute “checked” of the UI information 202 is rewritten as “false.”

Finally, the case in which the type of the UI information at the cursor position (3) involves screen transitions will be described. The UI information involving screen transitions refers to the UI information that allows an image different from an image being presently displayed to be displayed as a result of the manipulation of the UI information.

As illustrated in FIG. 11C, a link is displayed at the position 403 corresponding to the UI information 203, and by clicking the position 403, transition is made from one screen to another in accordance with the description of the tag 303. When the user moves the cursor 400 onto the position 403 and performs a click operation, the image processing unit 15 determines the type of the UI information at a position overlapping the cursor position on the basis of the UI metadata.

Here, since the UI information 203 is a link, which is the UI information involving screen transitions, the flow of the processing proceeds to step S52. Then, the UI metadata and the manipulated UI information ID (here, 206) are transmitted to the server 20 via the communicating unit 11 (step S52).

As described above, whichever type of the UI information the user clicks, the UI metadata and the manipulated UI information ID are transmitted to the server 20.

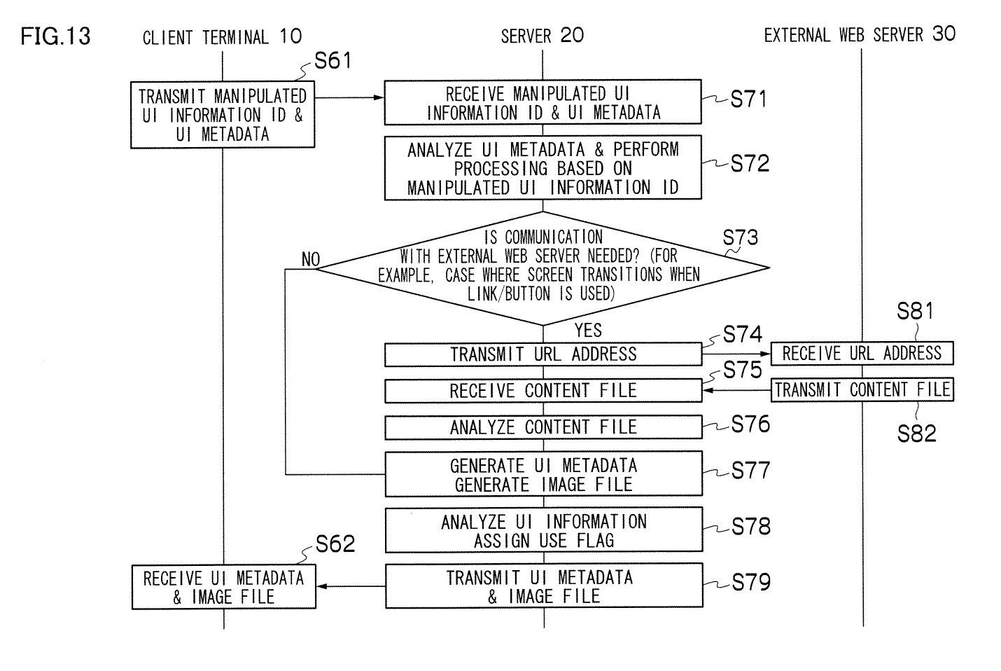

Next, the operation of the web page browsing system 100 based on the manipulated UI metadata will be described with reference to FIG. 13.

When the client terminal 10 transmits the UI metadata and the manipulated UI information ID (step S61), the server 20 receives the UI metadata and the manipulated UI information ID via the communicating unit 21 (step S71).

The web resource analyzing unit 24 analyzes the received UI metadata and the manipulated UI information ID to determine which UI information of the UI metadata was manipulated (step S72).

Also, the web resource analyzing unit 24 determines, on the basis of the manipulated UI information, whether or not communication with an external web server is necessary (step S73). For example, the communication is necessary if the link button is operated and thereby the screen transitions.

If the manipulated UI information is the UI information that needs the communication with the external web server (Yes in step S73), the server 20 acquires a destination URL from a content file stored in the storing unit, not illustrated, and transmits the URL to the corresponding external web server 30 (step S74). Then, the server 20 receives the corresponding content file from the external web server 30 (step S75) and the web resource analyzing unit 24 analyzes the content file of the destination (step S76).

In addition, the web resource analyzing unit 24 generates the UI metadata of the destination on the basis of a result of the analysis. Also, the web resource analyzing unit 24 generates an image file on the basis of the content file of the destination (step S77).

The UI analyzing unit 25 determines whether or not the UI information is needed for the client terminal 10, assigns a use flag to the UI metadata, and deletes the UI information that is not needed for the client terminal 10 from the UI metadata (step S78). The communication data controlling unit 23 transmits the image file of the destination and the UI metadata from which the UI information that is not needed for the client terminal 10 is deleted, in other words, the UI metadata on the UI information needed for the client terminal 10, to the client terminal 10 via the communicating unit 21 (step S79).

The client terminal 10 receives the image file and UI metadata via the communicating unit 11 and displays the image file on the displaying unit 13 as a screen of the destination (step S62).

In step S73, if the manipulated UI information is determined to be the UI information that does not need the communication with the external web server (No in step S73), the flow of the processing proceeds to step S77, where a content file related to the rewritten UI metadata is read out from the storing unit, not illustrated, to generate a new image file on the basis of the rewritten UI metadata. In addition, without generating a new image file, only a part of the image in which rewriting is required by the manipulation may be rewritten on the basis of an image of the base content file and the manipulated UI information ID.

The UI analyzing unit 25 determines whether or not the UI information is needed for the client terminal 10, assigns a use flag to the UI metadata, and deletes the UI information that is not needed for the client terminal 10 from the UI metadata (step S78). The communication data controlling unit 23 transmits this new image file and the UI metadata from which the UI information that is not needed for the client terminal 10 is deleted, in other words, the UI metadata on the UI information needed for the client terminal 10, to the client terminal 10 via the communicating unit 21 (step S79).

The client terminal 10 receives the image file and UI metadata via the communicating unit 11 and displays the image file on the displaying unit 13 (step S62).

The concrete example is illustrated. If the manipulated UI information is the UI information 201 (the text input field) illustrated in FIG. 11A, the rewritten UI metadata illustrated in FIG. 12B and the manipulated UI information ID 201 are transmitted from the client terminal 10 (step S61). The server 20 receives the rewritten UI metadata and the manipulated UI information ID 201 via the communicating unit 21 (step S71).

The web resource analyzing unit 24 reads out the content file related to the rewritten UI metadata from the storing unit, not illustrated, and generates a new image file on the basis of the rewritten UI metadata. As illustrated in FIG. 11C, this new image file is an image on which character string “XXOOΔΔ” input in the position of the text input field in step S50 is displayed.

If the manipulated UI information is the UI information 202 (the radio button) illustrated in FIG. 11C, the client terminal 10 transmits the rewritten UI metadata illustrated in FIG. 12C and the manipulated UI information ID 202 (step S61). The server 20 receives the rewritten UI metadata and the manipulated UI information ID 202 via the communicating unit 21 (step S71).

The web resource analyzing unit 24 reads out a content file related to the rewritten UI metadata from the storing unit, not illustrated, and generates a new image file on the basis of the rewritten UI metadata. As illustrated in FIG. 11C, this new image file is an image in which the radio button at the position 402 is unchecked.

In addition, if the manipulated UI information is the UI information 204 (the button), the client terminal 10 transmits the UI metadata (in this case, the UI metadata is not rewritten) and the manipulated UI information ID 204 (step S61). The server 20 receives the UI metadata and the manipulated UI information ID 204 via the communicating unit 21 (step S71).

The server 20 that has received them acquires a destination URL from the UI metadata, requests the corresponding content file from the corresponding external web server 30 (step S74), and receives the content file (step S75). On the basis of this content file, the web resource analyzing unit 24 generates the UI metadata as well as the web resource analyzing unit 24 generates the image file (step S76 and S77).

The UI analyzing unit 25 determines whether or not the UI information is needed for the client terminal 10, assigns a use flag to the UI metadata, and deletes the UI information that is not needed for the client terminal 10 from the UI metadata (step S78). The communication data controlling unit 23 transmits, to the client terminal 10, the image file of the destination and the UI metadata from which the UI information that is not needed for the client terminal 10 is deleted, in other words, the UI metadata on the UI information needed for the client terminal 10 (step S79). This image file is displayed on the displaying unit 13 (step S62).

As described above, also when a UI operation involving screen transitions is performed, a web page of a new destination can be displayed. In addition, the UI information can still be operated in the same manner as described above.

As described above, the web page browsing system 100 can achieve faster and user-friendly web page browsing.

In addition, since the server 20 determines the UI information that is not needed for the client terminal 10 so as not to transmit the determined UI information to the client terminal 10, the UI information that is not needed for the client terminal 10 can be prevented from being selected to reduce unnecessary internal processing and communication. Accordingly, server resources and communication traffic can be reduced.

It should be noted that the web page browsing system 100 includes the server 20 and the external web server 30 as separate servers, but an integrated server having the functions of the server 20 and the external web server 30 may also be used. Furthermore, this integrated server may also be connected to another external web server.

The presently disclosed subject matter can be provided as a computer-readable program code for causing a device (such as a server, mobile terminal or computer) to execute the above described process, a non-transitory computer-readable recording medium (for example, an optical disc, a magnetic disc or a magneto-optical disc) on which the computer-readable program code is stored or a computer program product including the computer-readable program code.

What is claimed is:

1. A website browsing system including a server and a client terminal connected to the server,
wherein the server comprises:
an acquiring device which acquires page content requested by the client terminal;
a converting device which converts the acquired page content into an image;
a UI information extracting device which extracts UI information from the acquired page content;
a determining device which determines whether or not the extracted UI information is needed for the client terminal for each of the UI information items;
a UI metadata generating device which generates UI metadata on the UI information determined, by the determining device, to be needed for the client terminal; and
a first transmitting device which transmits the converted image and the generated UI metadata to the client terminal, and
wherein the client terminal comprises:
a requesting device which requests desired page content from the server;
a first receiving device which receives the image of the requested page content and the UI metadata both transmitted from the server; and
a display controlling device which displays the image of the page content on a displaying device and displays the UI information on the displayed image on the basis of the UI metadata.

2. The website browsing system according to claim 1, wherein the UI metadata generating device generates base UI metadata on the basis of all the extracted UI information, assigns a use flag to the base UI metadata on the basis of a determination result from the determining device, and generates the UI metadata by deleting, from the base UI metadata, the UI information determined to be unnecessary for the client terminal by the determining device on the basis of the use flag.

3. The website browsing system according to claim 1, further comprising a storing device which stores a URL information table including a URL and a condition linked with the URL, the condition indicating whether or not a connection to the URL is needed,
wherein if the UI information is a link, the determining device determines whether or not the UI information is needed for the client terminal on the basis of the linked URL and the URL information table.

4. The website browsing system according to claim 3, wherein the URL information table includes as a condition indicating whether or not a connection to the URL is needed, at least one of a domain to which the client terminal can be connected, an address of a server to which the client terminal can be connected, a size of the page content, and a time required to render the page content.

5. The website browsing system according to claim 4, wherein if a domain of the linked URL is included in the URL information table, the determining device determines that the UI information is needed for the client terminal.

6. The website browsing system according to claim 4, wherein if an address of the server storing thereon page content corresponding to the linked URL is included in the URL information table, the determining device determines that the UI information is needed for the client terminal.

7. The website browsing system according to claim 4, wherein if a size of the page content corresponding to the linked URL is smaller than a size of the page content included in the URL information table, the determining device determines that the UI information is needed for the client terminal.

8. The website browsing system according to claim 4, wherein if a time required to render the page content corresponding to the linked URL is shorter than a time required to render the page content included in the URL information table, the determining device determines that the UI information is needed for the client terminal.

9. The website browsing system according to claim 3, wherein the server further comprises a present date and time acquiring device which acquires a present date and time, and
wherein the determining device determines whether or not the UI information is needed for the client terminal on the basis of the linked URL, information of a date and time when the client terminal can be connected, the date and time information being stored in the URL information table and linked with the linked URL, and the acquired present date and time.

10. The website browsing system according to claim 3, wherein the server further comprises a position information acquiring device which acquires position information of the client terminal, and
wherein the determining device determines whether or not the UI information is needed for the client terminal on the basis of the linked URL, information of a position to which the client terminal can be connected, the position information being stored in the URL information table and linked with the linked URL, and the acquired position information.

11. The website browsing system according to claim 1, further comprising a storing device which stores a user ID table including a user ID of the client terminal and attributes of the user ID, the attributes being linked with the user ID,
wherein if the UI information is a form, the determining device determines whether or not the UI information is needed for the client terminal on the basis of attributes of the UI information and the attributes in the user ID table.

12. A server constituting a website browsing system according to claim 1.

13. A non-transitory computer-readable recording medium including instructions stored thereon, such that when instructions are read and executed by a processor of a server, the processor is configured to perform the steps of:
receiving a request for desired page content from a client terminal;
acquiring the requested page content;
converting the acquired page content into an image;
extracting UI information from the acquired page content;
determining whether or not the extracted UI information is needed for the client terminal for each item of the UI information;
generating UI metadata on the UI information determined to be needed for the client terminal; and
transmitting the converted image and the generated UI metadata to the client terminal.

14. A website browse assisting method comprising the steps of:
receiving a request for desired page content from a client terminal;
acquiring the requested page content;
converting the acquired page content into an image;
extracting UI information from the acquired page content;
determining whether or not the extracted UI information is needed for the client terminal for each item of the UI information;
generating UI metadata on the UI information determined to be needed for the client terminal; and
transmitting the converted image and the generated UI metadata to the client terminal.

15. The website browse assisting, method according to claim 14, further comprising the steps of:
receiving the transmitted image and the UI metadata by the client terminal; and
displaying the received image on a displaying device of the client terminal and displaying the UI information on the displayed image on the basis of the UI metadata.
